(19) United States
(12) Patent Application Publication
(10) Pub. No.: US 2010/0241284 A1
(43) Pub. Date: Sep. 23, 2010

(54) ENERGY MANAGEMENT SYSTEM

(76) Inventors: Yuko Maeda, Ibaraki-shi (JP); Naohisa Morimoto, Osaka-shi (JP); Akiko Takamiya, Osaka-shi (JP)

Correspondence Address: Cheng Law Group, PLLC, 1100 17th Street, N.W., Suite 503, Washington, DC, 20036, US

(21) Appl. No.: 12/743,789

(22) PCT Filed: Nov. 20, 2008
(86) PCT No.: PCT/JP2008/071154

§ 371 Date: May 19, 2010

(30) Foreign Application Priority Data
Nov. 20, 2007 (JP) 2007-301049

(51) Int. Cl. G06F 1/28

(52) U.S. Cl. 700/295

(57) ABSTRACT

The energy management system capable of increasing consciousness of a user for energy saving and inducing the user to act for the energy saving by means of providing energy-saving information is provided. In the energy management system, a center device SV includes an information database where bits of knowledge are successively stored as energy-saving information. Upon receiving a display request to display a display screen for displaying the bits of knowledge from a terminal device such as a display control device CV, a personal computer PC, and a portable terminal PT, the center device SV generates image data of the display screen for displaying the bits of knowledge and transmits the same to the terminal device that is a requestor of the display screen. The terminal device displays the image data received from the center device SV.

### TECHNICAL FIELD

The present invention relates to an energy management system.

### BACKGROUND ART

A variety of energy management systems have heretofore been provided. As one embodiment of the energy management system, JP 3551302 discloses an electrical power monitoring system. The electrical power monitoring system can display household power consumption (e.g. main electrical energy at a distribution board). Further, the electrical power monitoring system can compare the household power consumption with power consumption of other homes and display a comparison result. As seen in the above, the electrical power monitoring system is capable of displaying the power consumption as well as the comparison result with other homes. Accordingly, it is possible to increase consciousness of a user for energy saving.

However, the electrical power monitoring system only displays the power consumption or the like. In order to achieve the energy saving, a user needs to consider and search a method of energy saving by oneself. This bothers the user extremely. Accordingly, there is a difficulty that a probability of making an actual act for the energy saving is low.

### DISCLOSURE OF INVENTION

In view of above insufficiency, the purpose of the present invention has been accomplished to provide an energy management system capable of increasing consciousness of a user for energy saving and prompting the user to act for the energy saving.

The energy management system in accordance with the present invention includes a home appliance located in a home and a terminal device connected to the home appliance. The home appliance includes a current measurement unit, an electrical energy calculation unit, and a processing unit. The current measurement unit is configured to measure a current flowing through each branch breaker connected to an output terminal of a main breaker. The electrical energy calculation unit is configured to calculate electricity usage at each of the branch breakers on the basis of a measurement of the current measurement unit. The processing unit is configured to generate information of electricity usage at the home on the basis of the electric usage calculated by the electrical energy calculation unit. The terminal device includes a display unit adapted in the use of displaying the information of the electricity usage generated by the processing unit. The energy management system includes a server connected to the home appliance via an outside network. The server includes a storage unit and an information transmission unit. The storage unit is configured to store energy-saving information including information indicative of a method of energy saving. The information transmission unit is configured to transmit the energy-saving information stored in the storage unit to the terminal device.

According to the present invention, the energy management system displays the energy-saving information. Accordingly, it is possible to increase consciousness of a user for energy saving. Moreover, it is possible to prompt the user to act for the energy saving, because the energy-saving information includes the information indicative of the method of the energy saving. As a result, the energy saving can be sufficiently improved.

In the preferred embodiment, the information transmission unit is configured to transmit the energy-saving information to the terminal device at a prescribed timing.

According to this embodiment, it is possible to display the energy-saving information on the terminal device even when the user has no access to the server.

In the preferred embodiment, the information transmission unit is configured to transmit the energy-saving information to the terminal device in response to a request from the terminal device.

According to this embodiment, the user can view the energy-saving information at any desired time.

### BRIEF DESCRIPTION OF DRAWINGS

FIG. 1 is a block diagram illustrating the features of the energy management system of one embodiment of the present invention,

FIG. 2 is another block diagram illustrating the features of the aforementioned energy management system,

FIG. 3 is a system diagram illustrating the configuration of the aforementioned energy management system,

FIG. 4 shows an arrangement of components in an integrated control panel of the aforementioned energy management system,

FIG. 5 is a block diagram of the terminal device of the aforementioned energy management system,

FIG. 6 shows an example of a display screen of the terminal device of the aforementioned energy management system,

FIG. 7A shows an example of a display screen of the terminal device of the aforementioned energy management system,

FIG. 7B shows an example of a display screen of the terminal device of the aforementioned energy management system,

FIG. 8 shows an example of a display screen of the terminal device of the aforementioned energy management system,

FIG. 9 shows an example of a display screen of the terminal device of the aforementioned energy management system,

FIG. 10 shows an example of a display screen of the terminal device of the aforementioned energy management system,

FIG. 11A shows an example of a display screen of the terminal device of the aforementioned energy management system,

FIG. 11B shows an example of a display screen of the terminal device of the aforementioned energy management system, and

FIG. 12 shows an example of a display screen of another terminal device of the aforementioned energy management system.

### BEST MODE FOR CARRYING OUT THE INVENTION

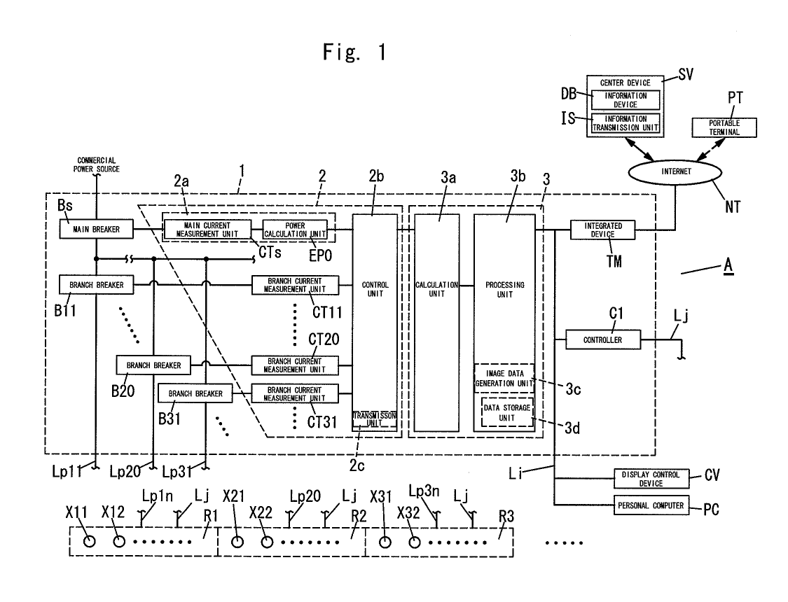

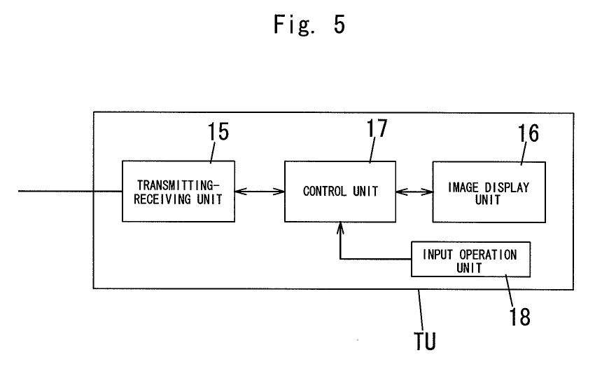

As shown in FIG. 1, the energy management system according to one embodiment of the present invention includes a home appliance A located in a home (a dwelling unit in the case of a housing complex), a terminal device TU (see FIG. 5) such as a personal computer PC, a display control device CV, and a portable terminal PT, and a center device (server) SV disposed outside the home. In this configuration, the center device SV is connected to the home appliance A via an internet NT, which is an external network (outside network).

The home appliance A includes an integrated control panel 1 disposed in the home and a plurality of electric apparatuses Xmn (symbols m and n are integers equal to or larger than 1; same hereinbelow) disposed in the home.

The electric apparatuses Xmn are connected to the integrated control panel 1 by a power line Lp that supplies commercial power and an information transmission line Lj. The electric apparatus Xmn can be illumination units, air conditioners, floor heating devices, and IH devices that are powered, controlled, and monitored by the integrated control panel 1.

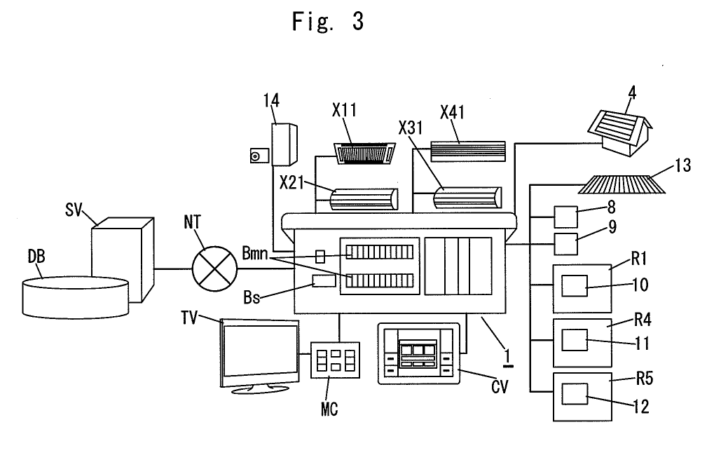

The personal computer PC and display control device CV are terminal devices having a web browser function and are disposed in the home. Such a terminal device (called hereinbelow, as necessary “a home terminal device”) disposed in the home may also be a net television TV having a web browser function, as shown in FIG. 3. The net television TV is connected to the integrated control panel 1 via a multimedia outlet MC. The portable terminal PT is a terminal device having a web browser function that is connected to the center device SV by the internet NT and mainly taken out for use by the user (that is, used outside the home). The terminal device (called hereinbelow, as necessary “an outside terminal device”) that is used outside the home may be a portable terminal device having a web browser function such as a notebook computer, a cellular phone, and a PDA (Personal Digital Assistance) that can be connected to the internet NT.

In the present embodiment, a home network using a typical communication protocol (TCP/IP, HTTP, or the like) is constituted by the integrated control panel 1 and the home terminal device. The home network is a local area network (LAN) conforming to a 100BASE-TX (IEEE 802.3u) standard. In the home network, the home terminal device corresponding to a network terminal is connected by a star wiring to the below-described integrated device TM corresponding to a layer 2 switch or a layer 3 switch inside the integrated control panel 1.

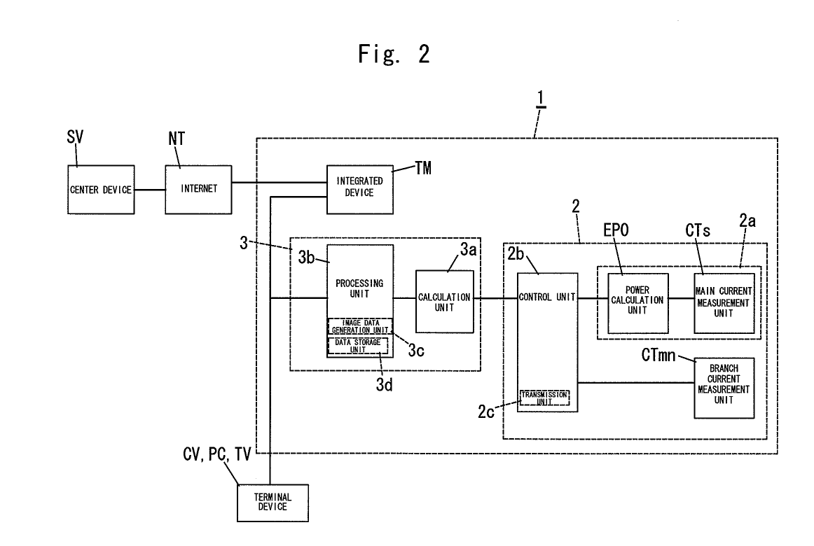

As shown in FIG. 1 and FIG. 2, the integrated control panel 1 includes a main breaker Bs, a plurality (only three are shown in FIG. 1) of branch breakers Bmn (m=1, 2, . . . , n=1, 2, . . . ), a current measurement unit 2, an energy management unit 3, the aforementioned integrated device TM, and an electric device controller C1.

A power supply line for commercial power supply that is drawn into the home from the outside (external power generation equipment or the like) is connected to the input terminal of the main breaker Bs. The main electric circuit (main line) is connected to the output terminal of the main breaker Bs. A plurality of electric lines Lpmn (m=1, 2, . . . , n=1, 2, . . . ) that are branch electric lines (branch lines) for supplying power to the electric apparatuses Xmn are branched off the main electric line. The eclectic lines Lpmn are led out to the outside from the integrate control panel 1, and the electric apparatuses Xmn are connected to the electric lines Lpmn. Therefore, power is supplied to the electric apparatuses Xmn through the electric lines Lpmn. The branch breakers Bmn are inserted between the electric lines Lpmn and the electric apparatuses Xmn.

For example, a plurality of rooms Rm (m=1, 2, . . . ) such as a living room, a bedroom, and a children's room are provided in the home. Each room Rm is provided with the respective electric apparatus Xmn (m=1, 2, n=1, 2, . . . ) or with an outlet for connection of electric apparatuses Xmn.

In the present embodiment, as shown in FIG. 1 and FIG. 3, an air conditioner X11 or an outlet 10 (an outlet for connection of electric apparatuses Xmn that are used inside the room R1, the electric apparatuses being other than the air conditioner X11) provided in the room R1 (for example, a living room) are connected to the branch breakers B1n (n=1, 2, . . . ). Power is supplied to the air conditioner X11 or outlet 10 via the corresponding electric line Lp1n (n=1, 2, . . . ). An air conditioner X21 provided in the room R2 (for example, a children's room) is connected to the branch breaker B20. Power is supplied to the air conditioner X21 via the electric line Lp20. Further, an air conditioner X31 provided in the room R3 (for example, a bedroom) is connected to the branch breaker B31. Power is supplied to the air conditioner X31 via the electric line Lp31. Further, an air conditioner X41 or an outlet 8 for a refrigerator provided in the room R4 (for example, a kitchen) is connected to the branch breaker B4n (n=1, 2, . . . ). Power is supplied to the air conditioner X41 or outlet 8 via the corresponding electric line Lp4n (n=1, 2, . . . ). Further, an outlet 11 (an outlet for connection of the electric apparatus used in the room R5) provided in the room R5 (for example, a Japanese room) is connected to the branch breaker B51. Power is supplied to the outlet 11 via the electric line Lp51. Further, a water heater 14, a floor heater 13, and an outlet 9 for a washing machine are connected to branch breakers Bmn (m=6, 7, . . . , n=1, 2, . . . ). Power is supplied to the water heater 14, floor heater 13, and outlet 9 via the corresponding electric lines Lpmn (m=6, 7, . . . , n=1, 2, . . . ).

The current measurement unit 2 is configured to measure a current flowing in the main breaker Bs and the branch breakers Bmn. More specifically, the current measurement unit 2 is provided with a main power measurement unit 2a, branch current measurement units CTmn (m=1, 2, . . . , n=1, 2, . . . ), and a control unit 2b.

The main power measurement unit 2a is configured to measure periodically main electrical energy supplied via the main breaker Bs (that is, electricity usage at the main breaker Bs). For example, the main power measurement unit 2a is provided with a main current measurement unit CTs that measures periodically the main current flowing in the main breaker Bs and a power calculation unit EPO that calculates electrical energy on the basis of measured main current. Thus, in the main power measurement unit 2a, the measured value of the main current measured by the main current measurement unit CTs is converted by the power calculation unit EPO into electrical energy, thereby calculating the main electrical energy supplied via the main breaker Bs.

The branch current measurement units CTmn measure periodically a value of a branch current flowing in each branch breaker Bmn for each branch breaker. For example, the branch current measurement unit CTmn is provided with a current sensor (not shown in the figure) that detects the branch current flowing in the electric line Lpmn and a sensor unit (not shown in the figure) that generates a detection data on the basis of the detection output of the current sensor. The sensor unit is configured to modulate the generated detection data into signals for transmission and output the modulated data to the control unit 2b. Such branch current measurement units CTmn are provided for the branch breakers Bmn, respectively.

The control unit 2b collects the measurement data of the main power of the main breaker Bs and of the branch current of each branch breaker Bmn. Further, the control unit 2b outputs the collected measurement data as detection information to the energy management unit 3.

More specifically, the control unit 2b demodulates the transmission signal inputted from the sensor unit, extracts the detection data, and successively sends the acquired detection data from the transmission unit 2c to the energy management unit 3.

The energy management unit 3 is configured to calculate the electricity usage on the basis of measurement data inputted from the current measurement unit 2. For example, the energy management unit 3 is provided with a calculation unit (electricity usage calculation unit) 3a and a processing unit 3b.

The calculation unit 3a is configured to calculate branch electrical energy (that is, electricity usage at the branch breakers Bmn) supplied via the branch breakers Bmn on the basis of the measurement data of the branch current for each branch breaker Bmn received from the transmission unit 2c.

The processing unit 3b is connected via a LAN cable to the integrated device TM and electric apparatus controller C1 located inside the integrated control panel 1. The processing unit 3b is configured to generate a screen data (e.g. a screen data for displaying the main electrical energy, a screen data for displaying the each branch electrical energy, and the like) displayed on the display control device CV on the basis of the main electrical energy and each branch electrical energy input from the calculation unit 3a. Further, the processing unit 3b has a web server function. The web server function of the processing unit 3b is a function which generates web contents (web pages) as an image data for displaying the various electric usage such as the main electrical energy and the branch electrical energy for each branch electric line and transmits (sends) the desired web contents to the terminal device TU in response to a request from the terminal device TU.

The processing unit 3b preliminarily stores a data (e.g. a name of the branch breaker: such as branch 1, branch 2, etc) of the branch breakers Bmn as a target of electrical energy detection. Further, the processing unit 3b stores as the data of the branch breakers Bmn information of names of electric apparatuses Xmn connected to the branch breakers Bmn and the usage sites thereof. For example, concerning the branch breakers Bmn provided separately for individual circuits such as an air conditioner or floor heating equipment, the processing unit 3b stores the names of corresponding electric apparatuses Xmn. Further, concerning the branch breakers Bmn that can be connected to unspecified electric apparatuses Xmn, rather than to individual circuits, the processing unit 3b stores the names of electric apparatuses Xmn (for example, an illumination device, a television, a water heating device, etc.) that can be connected to the branch breakers Bmn or main usage sites. In this case, the names of electric apparatuses (for example, hot carpet or iron) Xmn that are highly probable to be connected to the branch breakers Bmn and used by the user and the usage sites of such apparatuses are preferably designated.

The aforementioned processing unit 3b includes a data storage unit 3d and an image data generation unit 3c. The data storage unit 3d preliminarily stores information (for example, application, installation site, or branch current during shut down) of the electric apparatuses Xmn connected to the branch breakers Bmn. Further, the main electrical energy inputted from the calculation unit 3a and branch electrical energy for each branch breaker Bmn are successively stored in a time sequence in the data storage unit 3d. Further, the data storage unit 3d stores designation information of various kinds relating to power monitoring. The designation information is such as “Control Designation” and “Name Designation”.

The image data generation unit 3c is configured to generate the image data for displaying information of the electricity usage in the home (e.g. the various electric usage such as the main electrical energy and the branch electrical energy for each branch electric line) in response to various request signals inputted from the terminal device TU via the integrated device TM, and transmit (send) the generated image data to the terminal device TU that has sent the request signals.

The integrated device TM has an internet connection function corresponding to the type (telephone circuit, CATV circuit, optical fiber circuit, and the like) of the circuit for connecting to the internet NT. The home network is connected via the integrated device TM to the Internet NT, which is the external network. Further, the integrated device TM also controls the exchange of data in the network and has a packet processing function, a path switching function, a network security function and a function of control point of UPnP (Universal Plug and Play). In the present embodiment, the integrated device TM is connected to the processing unit 3b of the energy management unit 3 located in the integrated control panel 1 or the electric apparatus controller C1, personal computer PC outside the integrated control panel 1, and display control device CV via a LAN cable (LAN cable of enhanced category 5 or category 6). Further, the integrated device TM is connected to the center device SV or the portable terminal PT or another terminal device via the internet NT. Therefore, the center device SV is connected to the home network via the internet NT. As a result, by conducting data communication between the portable terminal PT and the center device SV via the internet NT, it is possible to control or monitor the electric apparatuses Xmn inside the home from an outside address by using the portable terminal PT.

The electric apparatus controller C1 has an interface function for the integrated device TM and an interface function for the electric apparatuses Xmn conforming to a unified standard of The Japan Electrical Manufacturers' Association (JEMA). Further, the electric apparatus controller C1 has a function (control function) of controlling individually the electric apparatuses Xmn via the information transmission path Lj and switching between active and inactive state of the apparatuses when the electric apparatus controller C1 receives a control request message from the terminal device TU via the integrated device TM. In addition, the electric apparatus controller C1 has a monitoring function. The monitoring function is a function of individually obtaining the operation state (operates “Light ON” or stopped “Light OFF”) of each electric apparatus Xmn via the information transmission line Lj when a monitoring request message is received from the terminal device TU via the integrated device TM and transmitting a message (operation state of each electric apparatus Xmn) in response to the control request or monitoring request to the terminal device TU that is a transmission source of the monitoring request message. Further, the apparatus name information of the electric apparatuses Xmn that are under autonomous control and name information rooms Rm is stored preliminarily in the electric apparatus controller C1. In addition, the electric apparatus controller C1 has a web server function. The web server function is a function of creating web contents (web page) for representing the name and also the operation state of the electric apparatuses Xmn by text or symbols and providing (distributing) the web contents to the terminal device TU in response to a request from the terminal device TU.

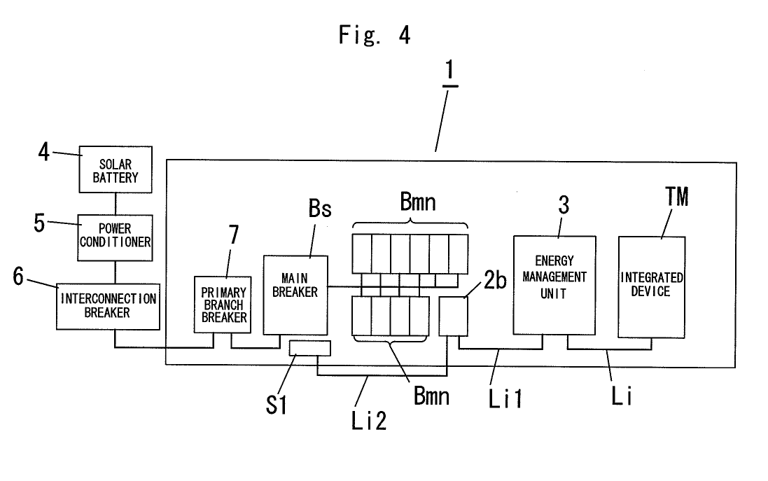

FIG. 4 shows an arrangement of the main breaker Bs, branch breakers Bmn, control unit 2b constituting the current measurement unit 2, energy management unit 3, and integrated device TM in the integrated control panel 1. A plurality of the branch breakers Bmn is arranged in two, upper and lower, rows and disposed in the transverse direction to the right of the main breaker Bs. The control unit 2b is disposed to the right of the branch breakers Bmn. A main power measurement sensor S1 constituting the main power measurement unit 2a is disposed below the main breaker Bs. The main power measurement sensor S1 is connected by a communication cable Li2 (for example, RS485 or the like) to the control unit 2b. Therefore, the main electrical energy of the main breaker Bs measured by the main power measurement sensor S1 is inputted via the communication cable Lit to the control unit 2b. Further, the energy management unit 3 is disposed to the right of the control unit 2b. The integrated device TM is disposed to the right of the energy management unit 3. The energy management unit 3 is connected to the integrated device TM by the LAN cable Li and connected to the control unit 2b by a communication cable Li1 (for example, RS485 or the like). Therefore, the measurement data of the main power of the main breaker Bs and the measurement data of the branch current of each branch breaker Bmn transmitted from the transmission unit 2c of the control unit 2b are inputted via the communication cable Li1 to the energy management unit 3.

In the present embodiment, as shown in FIG. 4, power can be also supplied from a solar battery 4 using solar energy, rather than only from the commercial power supply. The solar battery 4 is a DC power source in the form of a panel in which a large number of solar cells (elements that photoelectrically convert solar energy into electrical energy). The DC power generated by the solar battery 4 is converted by a power conditioner 5 into AC power and supplied to a load via a system breaker 6 and a primary branch breaker 7 in combination with the commercial power.

The center device SV is constituted by a typical computer device having a network function. The center device SV has a function (relay function) of relaying a message addressed to the integrated control panel 1 that is transmitted by the portable terminal PT via the Internet NT or a message addressed to the terminal device (e.g. the portable terminal PT or the like) not belonging to the home network that is transmitted by the integrated control panel 1. Further, the center device SV includes an information database (storage unit) DB and an information transmission unit. The information database DB is configured to store energy-saving information. The energy-saving information includes bits of knowledge (bits of knowledge concerning energy-saving). The bits of knowledge includes information indicative of a method of energy saving. The method of energy saving is, such as “turn off master switch of television”, “decrease preset temperature of air conditioner by 1 degree”, and the like. The aforementioned bits of knowledge (for example, the monthly bits of knowledge) are successively saved in the information database DB. The information transmission unit is configured to transmit to the terminal device TU the energy-saving information (in the present embodiment, the bits of knowledge) stored in the information database DB.

The information transmission unit of the present embodiment has a push-type information providing function and a pull-type information providing function. The push-type information providing function is a function of transmitting at a predetermined timing the bits of knowledge to an information reception unit of the terminal device TU. Meanwhile, the pull-type information providing function is a function of transmitting, in response to an information request message from the information reception unit, the bits of knowledge to the information reception unit that has transmitted the information request message.

As shown in FIG. 5, the terminal device TU is provided with a transmitting-receiving unit 15, an image display unit (display unit) 16 composed of a liquid crystal display, an input operation unit 18, and a control unit 17 that conducts complete control of the transmitting-receiving unit 15, image display unit 16, and input operation unit 18. The transmitting-receiving unit 15 serves to exchange data with the integrated device TM. The input operation unit 18 serves to input operation signals. For example, when the terminal device TU is the display control device CV, the input operation unit 18 is a touchpad disposed on the front surface of the image display unit 16 and together with the image display unit 16 constitutes a touch panel. When the terminal unit TU is the personal computer PC or portable terminal PT, the input operation unit 18 is constituted by a keyboard or ten keys.

Further, the terminal device TU includes the aforementioned information reception unit. The information reception unit is configured to, upon receiving the bits of knowledge from the information transmission unit of the center device SV, control the image display unit 16 to display the received bits of knowledge. The information reception unit is configured to transmit the information request message to the center device SV in response to a request from the user. The aforementioned information reception unit is constituted by the transmitting-receiving unit 15, the image display unit 16, the control unit 17, and the input operation unit 18.

As described in the above, the energy management system of the present embodiment displays the energy-saving information. Accordingly, it is possible to increase consciousness of a user for energy saving. Moreover, it is possible to prompt the user to act for the energy saving, because the energy-saving information includes the method of the energy saving. As seen from the above, the user acting continuously for the energy saving can sufficiently improve the energy saving.

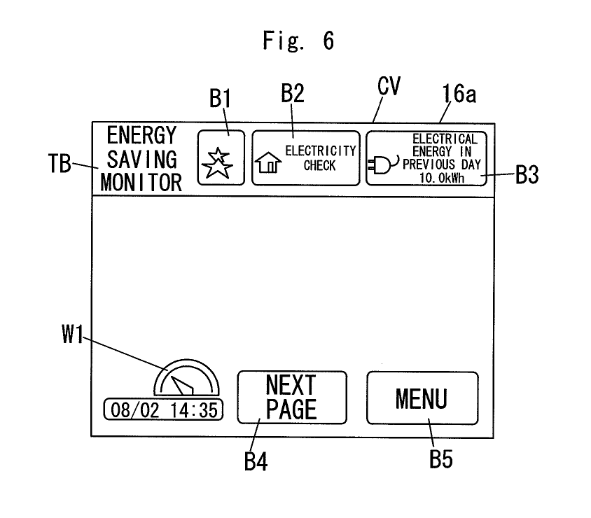

An operation example of the energy management system of the present embodiment is explained below with reference to FIG. 6 to FIG. 10. Particularly, an operation of providing the bits of knowledge from the center device SV to the terminal device TU is explained.

FIG. 6 shows an example of a screen that is displayed on a display screen 16a when the display control device CV is activated or when the display control device CV is switched from an intermediate screen to a top screen. A title bar TB indicating a screen name (in the present embodiment, “Energy Saving Monitor”) is displayed in the upper portion of the screen shown in FIG. 6. Further, in the screen shown in FIG. 6, an electricity consumption display button B1, an electric check button B2, and a comparison result display button B3 are displayed to the right of the title bar TB. The electricity consumption display button B1 serves to switch from the screen shown in FIG. 6 to a screen displaying electricity consumption. The electric check button B2 serves to switch from the screen shown in FIG. 6 to a screen displaying a usage state of electric apparatuses. The comparison result display button B3 serves to switch from the screen shown in FIG. 6 to a screen displaying a comparison result of the electricity usage. A display section W1 that displays the electricity usage in the current day is disposed in the lower section of the screen shown in FIG. 6. A next page button B4 for moving to the next page and a menu button B5 for moving to a menu screen are also displayed in the lower portion of the screen shown in FIG. 6.

When the user selects the menu button B5, the control unit 17 of the display control device CV controls the transmitting-receiving unit 15 so as to transmit a display request to display the menu screen to the energy management unit 3 via the integrated device TM. Upon receiving the display request, the energy management unit 3 transmits a webpage for displaying the menu screen to a transmission source of the display request (that is, the display control device CV which has transmitted the display request). As a result, the webpage received by the transmitting-receiving unit 15 is displayed on the display screen 16a of the display control device CV.

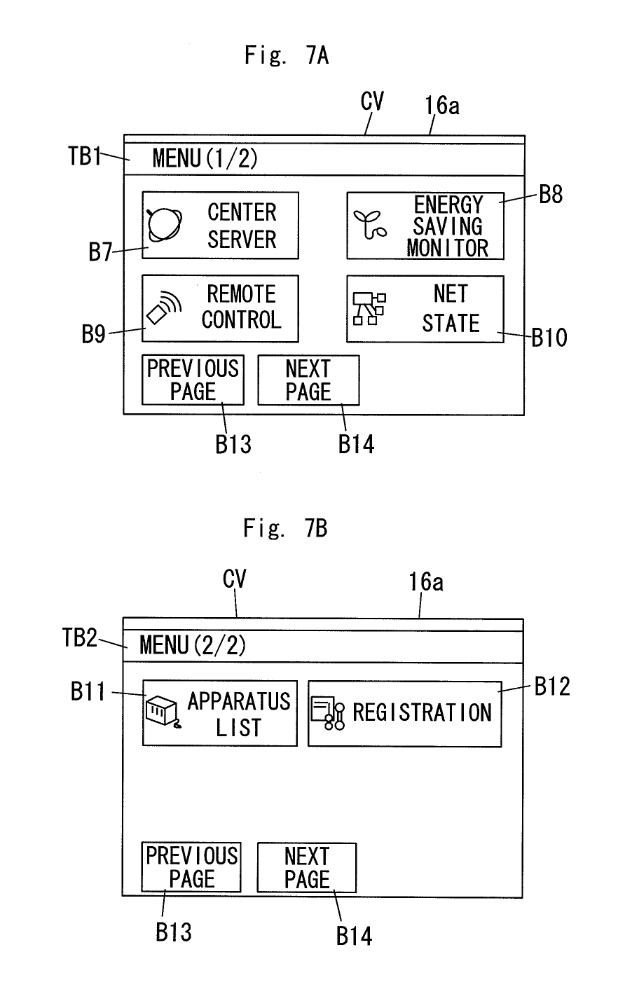

FIGS. 7A and 7B show an example of the menu screen displayed on the display screen 16a of the display control device CV. A title bar TB1 indicating a screen name (in FIG. 7A, “menu (1/2)”) is displayed in the upper portion of the screen shown in FIG. 7A. Menu selection buttons B7 to B10 for selecting a desired menu are displayed in the center of the screen shown in FIG. 7A. A previous page button B13 and a next page button B14 for moving to the previous page or next page are displayed in the lower portion of the screen shown in FIG. 7A. The text (“Center Server”, “Energy Saving Monitor”, “Remote Control”, and “Net State”) that indicates corresponding menu contents is displayed on the respective menu selection buttons B7 to B10. Meanwhile, a title bar TB2 indicating a screen name (in FIG. 7B, “menu (2/2)”) is displayed in the upper portion of the screen shown in FIG. 7B. Menu selection buttons B11 and B12 for selecting a desired menu are displayed in the center of the screen shown in FIG. 7B. A previous page button B13 and a next page button B14 for moving to the previous page or next page are displayed in the lower portion of the screen shown in FIG. 7B in the same manner as the screen shown in FIG. 7A. The text (“Apparatus List” and “Registration”) that indicates corresponding menu contents is displayed on the respective menu selection buttons B11 and B12.

When the next page button B14 is selected on the screen shown in FIG. 7A, the screen shown in FIG. 7B is displayed on the display screen 16a by means of processing similar to that described above. Meanwhile, where the previous page button B13 is selected on the screen shown in FIG. 7B, the menu screen, which is the screen shown in FIG. 7A, is displayed on the display screen 16a by means of processing similar to that described above.

The aforementioned menu selection button B7 serves to switch from the screen shown in FIG. 7A to a screen provided by the center device SV. When the menu selection button B7 is selected, the control unit 17 of the display control device CV controls the transmitting-receiving unit 15 so as to transmit a display request to display a menu screen to the center device SV via the integrated device TM. Upon receiving the display request via the integrated device TM, the center device SV transmits a webpage for displaying the menu screen to a transmission source of the display request (the display control device CV which has transmitted the display request). As a result, the webpage received by the transmitting-receiving unit 15 is displayed on the display screen 16a of the display control device CV.

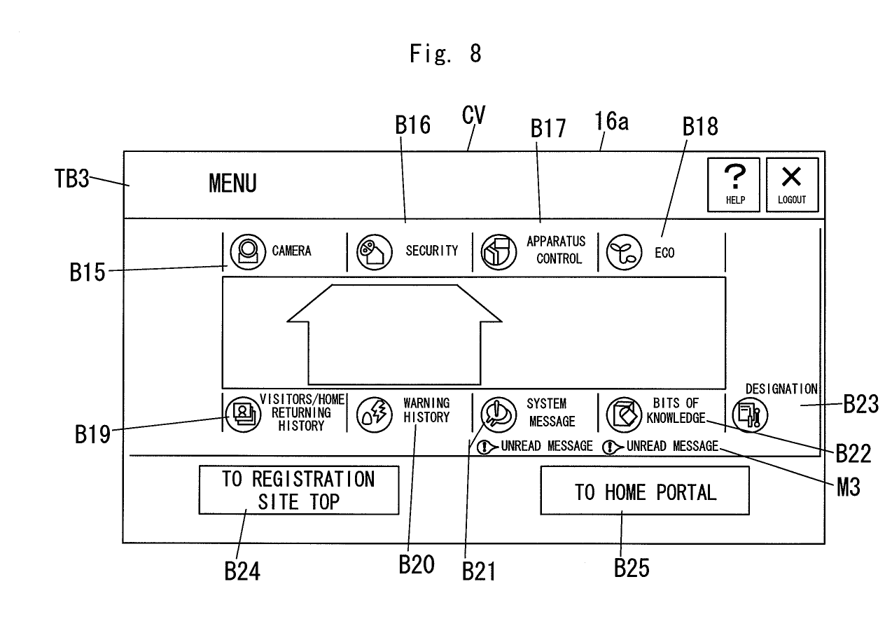

FIG. 8 shows an example of the menu screen provided by the center device SV. A title bar TB3 indicating a screen name (in the present screen, “menu”) is displayed in the upper portion of the screen shown in FIG. 8. Menu selection buttons B15 to B23 for selecting a desired menu are displayed in the center of the screen shown in FIG. 8. Further, a movement button B21 for moving to a top page of a registration site and a movement button B22 for moving to a home portal are displayed in the lower portion of the screen shown in FIG. 8. The text (such as, “Camera”, “Apparatus Control”, “Eco”, and “Bits of Knowledge”) that indicates corresponding menu contents is displayed on the respective menu selection buttons B15 to B23.

The menu selection button B22 serves to switch from the screen shown in FIG. 8 to a screen for displaying the bits of knowledge. When an unread message is present, the selection button B22 is displayed together with a message M3. The message M3 is a message of notifying the user of presence of an unread message.

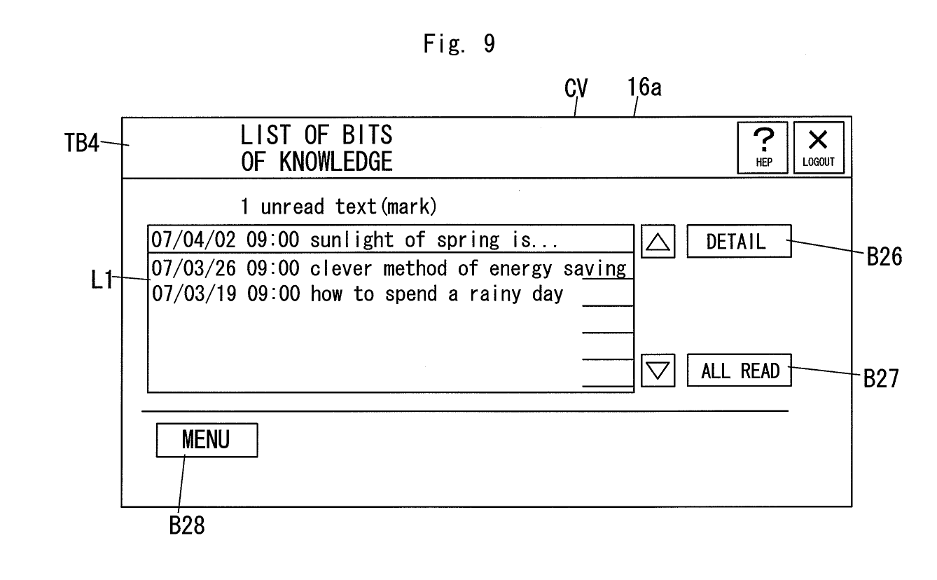

When the selection button B22 is selected on the screen shown in FIG. 8, a screen (screen for displaying a list of the bits of knowledge) shown in FIG. 9 is displayed on the display screen 16a by means of processing similar to that described above. A title bar TB4 indicating a screen name (in the present screen, “List of Bits of Knowledge”) is displayed in the upper portion of the screen shown in FIG. 9. A list L1 displaying the bits of knowledge in date order is displayed in the center of the screen shown in FIG. 9. Further, a menu button B28 for moving to the screen shown in FIG. 8 is displayed in the lower portion of the screen shown in FIG. 9. Moreover, in the screen shown in FIG. 9, a detail button B26 and read button B27 are displayed to the right of the list L1. The detail button B26 is a button for moving to a displaying screen for displaying detail information of each of the bits of knowledge. The read button B27 is a button for marking all of the bits of knowledge displayed in the list L1 as read.

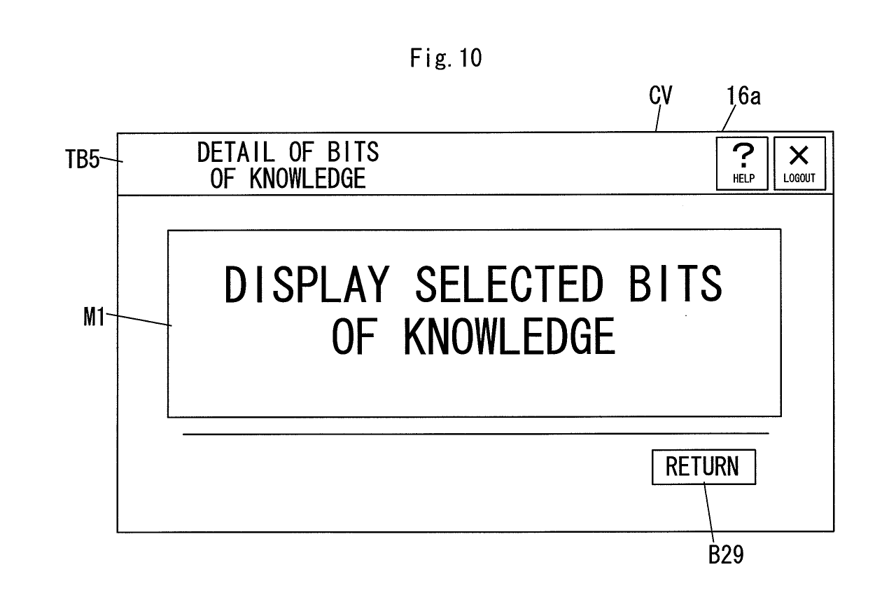

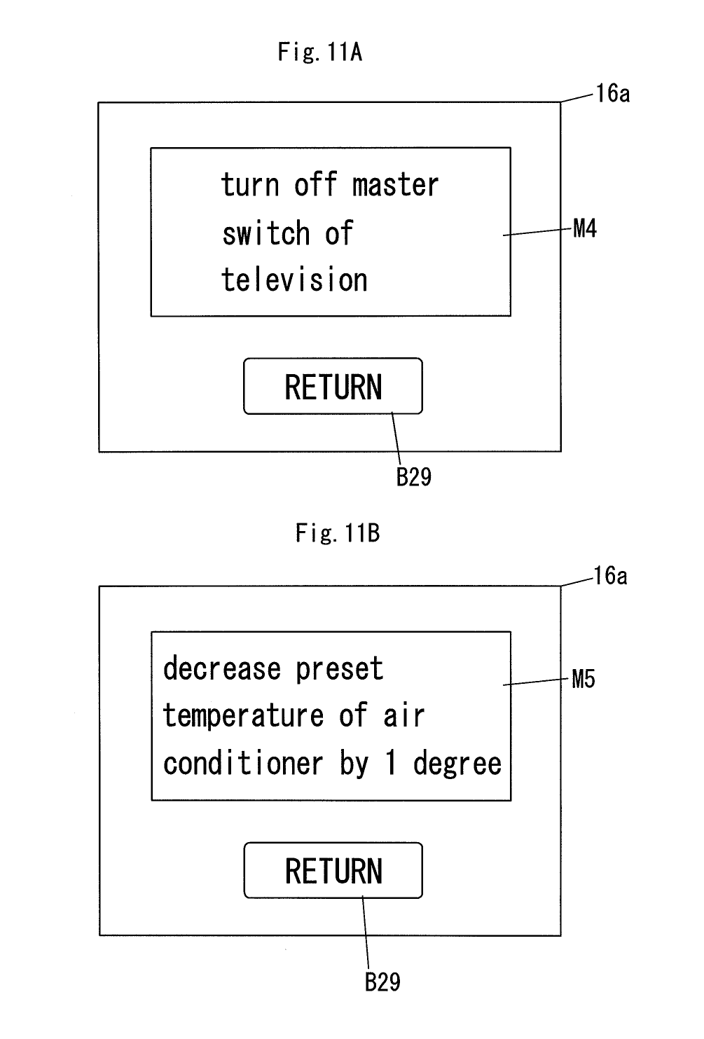

In order to display the detail information of the bits of knowledge displayed in the list L1, it is sufficient the user selects the bits of knowledge to view and then selects the detail button B27 on the screen shown in FIG. 9. In response to this operation, a screen of displaying details of bits of knowledge shown in FIG. 10 is displayed on the display screen 16a by means of processing similar to that described above. A title bar TB5 indicating a screen name (in the present screen, “Detail of Bits of Knowledge”) is displayed in the upper portion of the screen shown in FIG. 10. A detailed message M1 in relation to the bits of knowledge selected from the list L1 in the screen shown in FIG. 9 is displayed in the center of the screen shown in FIG. 10. A message M4 shown in FIG. 11A and a message M5 shown in FIG. 11B show a specific example of the message M1. Further, a return button B29 for moving to the screen shown in FIG. 9 is displayed in the lower portion of the screen shown in FIG. 10.

As described in the above, when the terminal device TU transmits to the center device SV the display request (the aforementioned information request message) to display the screen for displaying the bits of knowledge, the center device SV transmits to the terminal device TU which has transmitted the display request the webpage including the bits of knowledge. Therefore, the user can view the energy-saving information at any desired time. Although an explanation is made to the instance where the terminal device TU is the display control device CV, to execute processing similar to that described above is capable of displaying the bits of knowledge on the display screen 16a even when the terminal device TU is the personal computer PC or the net television TV.

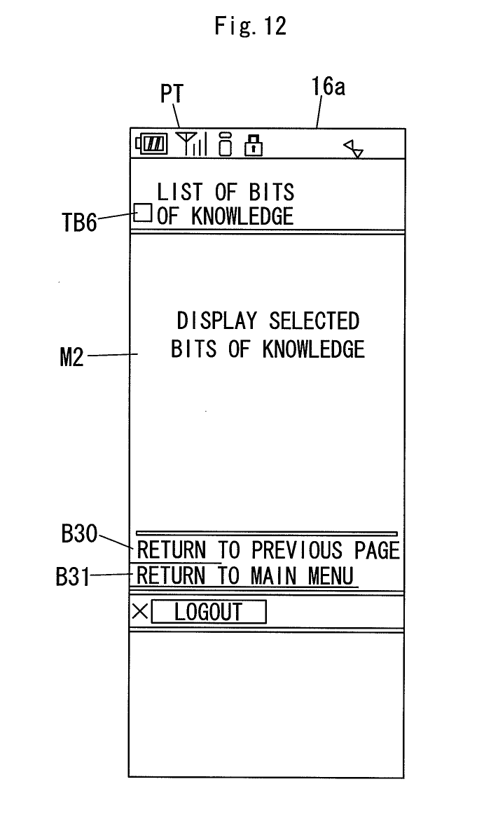

Next, an explanation is made to the instance where the terminal device TU is the portable terminal PT such as cellular phone. FIG. 12 shows an example of the screen of displaying details of bits of knowledge (corresponding to the screen shown in FIG. 10) of the portable terminal PT. A method of displaying the screen shown in FIG. 12 is explained below. First, the user accesses the center server SV from the portable terminal PT via the internet NT. In this case, the control unit 17 of the portable terminal PT controls the transmitting-receiving unit 15 so as to transmit a display request to display a menu screen (corresponding to the screen shown in FIG. 8) to the center device SV via the internet NT. Upon receiving the display request via the internet NT, the center device SV transmits via the internet NT a webpage for displaying the menu screen to the portable terminal PT that is a transmission source of the display request. Therefore, the webpage received by the transmitting-receiving unit 15 is displayed on the display screen 16a of the portable terminal PT. Thereafter, when a selection button for switching to a screen (corresponding to the screen shown in FIG. 9) for displaying the list of the bits of knowledge is selected on the menu screen of the portable terminal PT, the screen (bits of knowledge list displaying screen) for displaying the list of the bits of knowledge is displayed on the display screen 16a by means of processing similar to that described above. Further, when the user selects the bits of knowledge to view and then selects a detail button on the bits of knowledge list displaying screen, the bits of knowledge selected by the user is displayed on the display screen 16a by means of processing similar to that described above. In addition, a title bar TB6 indicating a screen name (in the present screen, “List of Bits of Knowledge”) is displayed in the upper portion of the screen shown in FIG. 12. A detailed message M2 in relation to the selected bits of knowledge is displayed in the center of the screen shown in FIG. 12. Further, a return button B30 for moving to the previous screen and a menu button B31 for moving to the menu button are displayed in the lower portion of the screen shown in FIG. 12.

Moreover, when new bits of knowledge are present, the center device SV may display presence of the new bits of knowledge on, for example, an initial screen (e.g. the screen shown in FIG. 6 or FIG. 8) of the terminal device TU. In this instance, the terminal device TU displaying a message indicative of the presence of the new bits of knowledge on the display screen 16a of the image display unit 16 is capable of notifying the user of addition of the new bits of knowledge. Although the bits of knowledge concerning the energy saving is exemplified as the information indicative of the method of the energy saving in the present embodiment, the information indicative of the method of the energy saving may be selected from advice based on the measured electricity usage and the like.

In the above explanation, the center device SV transmits the bits of knowledge to the terminal device TU in response to the request from the terminal device TU. This operation is realized by the pull-type information providing function of the information transmission unit. Meanwhile, the information transmission unit of the center device SV of the present embodiment has the push-type information providing function. Therefore, for example, the center device SV can transmit periodically (for example, once a week) the energy-saving information to the preliminarily registered terminal device TU without any request from the terminal device TU. In this case, it is possible to display the energy-saving information on the terminal device TU even if the user does not access the center device SV. It is noted that an e-mail can be utilized as a method of transmitting the energy-saving information to the terminal device TU.

In the present embodiment an example is shown in which the energy management unit 3 and integrated device TM are arranged together with the current measurement unit 2 in one integrated control panel 1. However, the energy management unit 3 and integrated device TM may be provided as a control panel separate from the current measurement unit 2. In this case, the current measurement unit 2 and the energy management unit 3 may be connected by a communication cable.

1. An energy management system comprising:
a home appliance located in a home; and
a terminal device connected to said home appliance,
wherein said home appliance comprises a current measurement unit, an electrical energy calculation unit, and a processing unit,
said current measurement unit being configured to measure a current flowing through each branch breaker connected to an output terminal of a main breaker,
said electrical energy calculation unit being configured to calculate electricity usage at each of said branch breakers on the basis of a measurement of said current measurement unit, and
said processing unit being configured to generate information of electricity usage at the home on the basis of the electric usage calculated by said electrical energy calculation unit,
wherein said terminal device comprises a display unit adapted in the use of displaying the information of the electricity usage generated by said processing unit,
wherein said energy management system comprises a server connected to said home appliance via an outside network, and
wherein said server comprises a storage unit and an information transmission unit,
said storage unit being configured to store energy-saving information including information indicative of a method of energy saving, and
said information transmission unit being configured to transmit the energy-saving information stored in said storage unit to said terminal device.

2. An energy management system as set forth in claim 1,
wherein said information transmission unit is configured to transmit the energy-saving information to said terminal device at a prescribed timing.

3. An energy management system as set forth in claim 1,
wherein said information transmission unit is configured to transmit the energy-saving information to said terminal device in response to a request from said terminal device.
